(19) United States
(12) Patent Application Publication
(10) Pub. No.: US 2012/0048802 A1
(43) Pub. Date: Mar. 1, 2012

(54) Non-aerated biodestruction of biochemical oxygen demand

(76) Inventors: Jess C. Brown, Sarasota, FL (US); Rick D. Wheadon, Alpine, UT (US)

(21) Appl. No.: 12/807,298

(22) Filed: Sep. 1, 2010

(51) Int. Cl. C02F 3/12

(52) U.S. Cl. 210/610

(57) ABSTRACT

The present invention may use exogenous oxidants to supplement use of oxygen in the treatment of municipal wastewater. The new method may implement non-aerated biodestruction using an exogenous oxidant material combined with a primary treatment municipal wastewater to reduce wastewater treatment aeration requirements. The municipal wastewater influent for treatment in an activated sludge treatment process may be combined with an exogenous oxidant material in a non-aeration process to produce a blended stream. The blended stream may be treated in a bioreactor.

### BACKGROUND OF THE INVENTION

This invention relates to processes for treatment of wastewater that may be a secondary treatment and may include activated sludge processing, and may use alternative exogenous oxidants to supplement use of oxygen in the biological reaction with biochemical oxygen demand (BOD). The new method may implement non-aerated biodestruction in a process.

Activated sludge is a commonly used process in secondary municipal wastewater treatment. The United States EPA estimates that in the United States, activated sludge processes are used to treat sewage from 75 percent of the population at a total flow of approximately 49 billion gallons per day. During activated sludge treatment, bacteria suspended in large tanks transfer electrons from organic pollutants, that is, biochemical oxygen demand or BOD, to dissolved oxygen, thereby producing CO2, water, and biomass, and rendering the wastewater safe for discharge or reuse. Since this biochemical transformation consumes dissolved oxygen, the primary oxidant, activated sludge treatment requires the constant addition of air or pure oxygen, which requires a large electrical energy input to drive blowers and other equipment that deliver the air or oxygen to the bottom of the activated sludge tanks. Aeration typically requires approximately 900 KWh of electricity per million gallons of wastewater treated. Depending on the configuration of a particular treatment plant, unit process efficiency, and the level of treatment provided, this represents up to 60 percent of the total energy required for a typical activated sludge wastewater plant. Therefore, any process that can reduce activated sludge aeration requirements without compromising treatment performance would have a transformational impact on wastewater treatment energy requirements and costs.

### SUMMARY OF THE INVENTION

The present invention is directed to methods and processes for treatment of municipal wastewater. The new method may implement non-aerated biodestruction using an exogenous oxidant material combined with a primary treatment municipal wastewater to reduce wastewater treatment aeration requirements. The municipal wastewater influent for treatment in an activated sludge treatment process may be combined with an exogenous oxidant material in a non-aeration process to produce a blended stream. The blended stream may be treated in a bioreactor.

These and other features, aspects and advantages of the present invention will become better understood with reference to the following drawings, description and claims.

### BRIEF DESCRIPTION OF THE DRAWINGS

FIG. 1 illustrates a non-aerated treatment process operated in combination with an activated sludge treatment process according to an embodiment of the invention.

### DETAILED DESCRIPTION

The following detailed description represents the best currently contemplated modes for carrying out the invention. The description is not to be taken in a limiting sense, but is made merely for the purpose of illustrating the general principles of the invention.

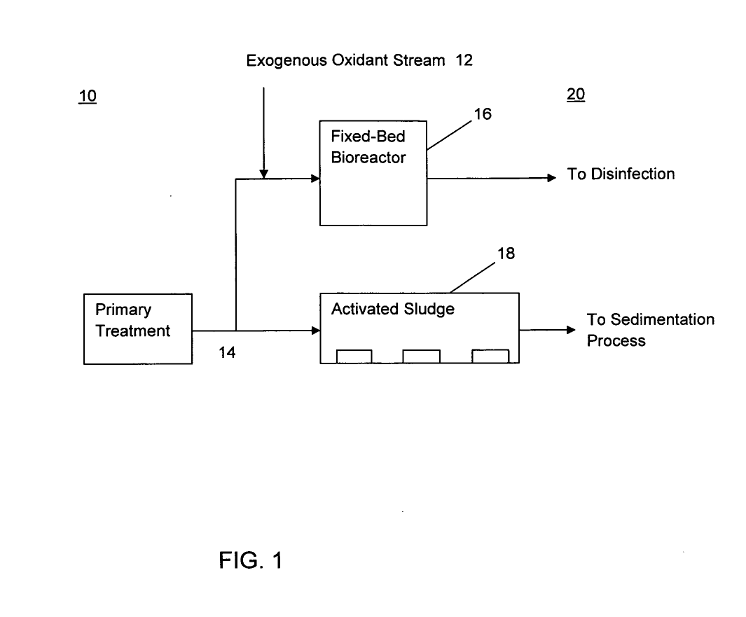

Referring to FIG. 1, a method for secondary wastewater treatment 10 may use alternative exogenous oxidants 12 to supplement the use of the oxygen in the biological reaction with organic pollutants, the biochemical oxygen demand or BOD. The method or process may operate to cause the transfer of electrons from the organic pollutant BOD to alternative oxidants such as nitrate or perchlorate. This is not a process intended as in other wastewater treatment processes to produce and degrade nitrate, for example, nitrification and denitrification processes. The biodestruction process implements the importation of an alternative exogenous oxidant 12 stream that is then blended with municipal wastewater 14 and treated in a bioreactor 16 that may be separate from the existing secondary biological process.

Examples of alternative exogenous oxidant 12 streams may include nitrate-laden wastes generated during the production of nitroglycerin, perchlorate-laden wastes generated during the production of solid rocket fuel, reject streams from separations-based water treatment processes, for example, membranes and ion exchange, that remove nitrate from drinking water, and other sources of oxidants such as nitrate, perchlorate and the like. As the concentration of alternative exogenous oxidants 12 increases in municipal wastewater treatment 10, the mass of dissolved oxygen required for BOD oxidation decreases. This biodestruction process may diminish the aeration requirements and the energy requirements for secondary wastewater treatment 10.

The blending of an alternate exogenous oxidant 12 with a municipal wastewater 14 stream may be done over a wide range of ratios that may be determined based on the wastewater 14 influent, activated sludge 18 and availability of oxidant. The treatment bioreactor 16 may be of various types, such as, suspended growth, fixed bed, or membrane-based fixed-film reactors. Experiments have shown that a fixed-film bioreactor can provide good performance. The oxidant-reducing metabolic activity of a biofilm may be more stable than that of suspended cultures. Fixed-bed (FXB) bioreactors may be particularly pertinent due to the ability to act as a filter as well as a bioreactor. Thus, a secondary sedimentation process may be unnecessary for making total suspended solids (TSS) and turbidity limits. The non-aerated biodestruction process 20 may be operated alone as a secondary wastewater treatment 10 or may be implemented as a parallel process with an activated sludge process 18 as illustrated in FIG. 1.

Full Scale Demonstration. Based on design criteria developed during pilot testing, a 3.8-MGD facility was constructed at a municipal district treatment facility, and operation of this facility began in 2009. A membrane-based drinking water treatment plant discharges a perchlorate-laden concentrate stream to the local sewer. In the sewer line, the concentrate blends with raw municipal wastewater from the collection system and travels directly to a new headworks facility (3-mm step screens+grit removal) and then on to one of six FXB reactors, all of which were constructed at the existing wastewater treatment facility. Raw wastewater from the collection system is treated through the conventional wastewater treatment processes, which include oxidation ditches (with a 14-hour hydraulic residence time), secondary sedimentation, and disinfection. The FXB train treats ⅓ to ½ of the total wastewater flow, uses no aeration, has an empty-bed contact time of 10 minutes, and has a footprint that is one-twentieth the size of the conventional secondary process. Preliminary data show effluent that even under these conditions, BOD5 and TSS levels in the effluent from the FXB process are similar to those in the conventional secondary treatment effluent.

The process 20 may create a new reclaimed water source by blending an exogenous oxidant 12 stream with municipal wastewater 14 followed by treatment in a FXB bioreactor 16. The dilution effect and the presence of dissolved oxygen (DO), nitrate, and perchlorate in the exogenous oxidant 12 stream decreases BOD5 concentrations in the municipal wastewater. The result should be a lower-energy approach for generating secondary treatment wastewater. Suspended solids and turbidity may also be removed across the bioreactor by filtration, making it possible to meet Type I reuse requirements in a single, compact process.

While the invention has been particularly shown and described with respect to the illustrated embodiments thereof, it will be understood by those skilled in the art that the foregoing and other changes in form and details may be made therein without departing from the spirit and scope of the invention.

We claim:

1. A method for treatment of municipal wastewater comprising:
combining a municipal wastewater influent with with an exogenous oxidant material in a non-aerated process to produce a blended stream; and
processing said blended stream in a bioreactor.

2. The method as in claim 1 wherein said exogenous oxidant material contains at least one of perchlorate, nitrate, bromate, selenate and chromate.

3. The method as in claim 1 wherein said non-aerated process is combined to operate in parallel with an aerated, activated sludge treatment process.

4. The method as in claim 1 wherein the quantity of said exogenous oxidant material is sufficient to meet the BOD requirement in said non-aeration process.

5. The method as in claim 1 wherein said bioreactor is selected from the group consisting of a suspended growth reactor, a fixed-bed reactor, and a membrane-based fixed-film reactor.

6. The method as in claim 3 wherein said bioreactor is separate from an aerated wastewater treatment biological process.
